(19) United States
(12) Patent Application Publication
(10) Pub. No.: US 2011/0173266 A1
(43) Pub. Date: Jul. 14, 2011

(54) IMAGE SHARING CONTROLLER, IMAGE SHARING SYSTEM, IMAGE SHARING CONTROLLING METHOD, ITS PROGRAM, AND RECORDING MEDIUM RECORDED WITH THE PROGRAM

(75) Inventors: Fumikazu Ohashi, Kanagawa (JP); Shinichi Shirasaka, Kanagawa (JP)

(73) Assignees: PIONEER CORPORATION, Kawasaki-shi (JP); PIONEER SOLUTIONS CORPORATION, Kawasaki-shi (JP)

(21) Appl. No.: 13/119,628

(22) PCT Filed: Sep. 18, 2008
(86) PCT No.: PCT/JP2008/066835

§ 371 Date: Mar. 17, 2011

(51) Int. Cl. G06F 15/16

(52) U.S. Cl. 709/205

(57) ABSTRACT

An image-sharing server of an image-sharing system acquires candidate storage data including an update image currently displayed on an image-providing terminal. When, for instance, a predetermined reception band of a second image-receiving terminal is narrower than an optimum transmission band of the image-providing terminal, the image-sharing server specifies the last update data in an order for the update data to be stored in a second transmission buffer as comparison data. Further, when determining that an update region of the comparison data is included in an update region of the candidate storage data, the image-sharing server deletes the comparison data and stores the candidate storage data in the second transmission buffer. Subsequently, the image-sharing server transmits the update data of the second transmission buffer to a second receiving terminal in the order for the update data to be stored to update the image currently displayed on the second image-receiving terminal to update data.

### TECHNICAL FIELD

The present invention relates to an image-sharing controller, an image-sharing system, an image-sharing controlling method, its program, and a recording medium recorded with the program.

### BACKGROUND ART

There has conventionally been known a conference system using a plurality of terminals connected to each other via a network (see, for instance, Patent Literature 1).

In the conference system disclosed in Patent Literature 1, communication speeds of a plurality of communication-conference terminals are stored by a multipoint communication-conference connection unit. When the communication speeds of the communication-conference terminals are different, the conference system is configured to transmit an image file provided by deteriorating and compressing an image in accordance with the communication speeds, thereby allowing all the communication-conference terminals to simultaneously receive the image file.

Patent Literature 1: JP-A-2000-22832

### DISCLOSURE OF THE INVENTION

### Problems to be Solved by the Invention

With the arrangement disclosed in Patent Literature 1, depending on a communication speed of the terminals, an image quality may be deteriorated by compressing an image data. An image requiring fine representation (e.g., drawings) may not be suitably displayed.

An object of the invention is to provide an image-sharing controller that enables a receiving terminal having a different communication band from a transmitting terminal to suitably display an image that is currently displayed on the transmitting terminal, an image-sharing system, an image-sharing controlling method, its program, and a recording medium recorded with the program.

### Means for Solving the Problems

An image-sharing controller according to an aspect of the invention is connected to a plurality of terminals via a network and operates the plurality of terminals to display an image transmitted and received between the plurality of terminals, and includes: a receiver that receives update data from a transmitting terminal of the plurality of terminals, the update data including: an update image of at least a part of an image currently displayed on the transmitting terminal; and update region location information showing a location of an update region of the update image in the image; a transmission buffer that temporarily stores the update data received by the receiver; a transmitter that transmits the update data stored in the transmission buffer to a receiving terminal of the plurality of terminals in an order for the update data to be stored to update the update region of the image currently displayed on the receiving terminal to the update image; a comparison-target recognizing section that recognizes as comparison data the update data that is stored last in the order for the update data to be stored in the transmission buffer for storing the update data to be transmitted to the receiving terminal; a deletion controller that deletes the comparison data when it is determined that an update region of the comparison data recognized by the comparison-target recognizing section is included in an update region of newly-received update data by the receiver; and a storage controller that stores the newly-received update data in the transmission buffer.

An image-sharing controller according to another aspect of the invention is connected to a plurality of terminals via a network and operates the plurality of terminals to display an image transmitted and received between the plurality of terminals, and includes: a receiver that receives update data from a transmitting terminal of the plurality of terminals, the update data including: an update image of at least a part of an image currently displayed on the transmitting terminal; and update region location information showing a location of an update region of the update image in the image; a transmission buffer that temporarily stores the update data received by the receiver; a transmitter that transmits the update data stored in the transmission buffer to a receiving terminal of the plurality of terminals in the order for the update data to be stored to update the update region of the image currently displayed on the receiving terminal to the update image, the number of the receiving terminal being equal to that of the transmission buffer; a threshold excess judgment section that requests the transmitting terminal to transmit the update data of the entire region including the update image of the entire image when specifying the transmission buffer, in which the update data are stored over a threshold, as a threshold-exceeding buffer; a deletion controller that deletes untransmitted update data stored in the threshold-exceeding buffer when the update data of the entire region are transmitted from the transmitting terminal as requested by the threshold excess judgment section; and a storage controller that stores the update data of the entire region in the threshold-exceeding buffer.

An image-sharing system according to still another aspect of the invention includes: a plurality of terminals capable of displaying an image; and the above-described image-sharing controller, the image-sharing controller being connected to the plurality of terminals via a network and operating the plurality of terminals to display an image transmitted and received between the plurality of terminals.

An image-sharing controlling method according to a further aspect of the invention is a method by a computer for displaying an image transmitted and received between a plurality of terminals connected to each other via a network includes: receiving update data from a transmitting terminal of the plurality of terminals, the update data including an update image of at least a part of an image currently displayed on the transmitting terminal and update region location information showing a location of an update region of the update image in the image; temporarily storing the update data in a transmission buffer; transmitting the update data stored in the transmission buffer to a receiving terminal of the plurality of terminals in the order for the update data to be stored to update the update region of the image currently displayed on the receiving terminal to the update image; recognizing last-stored update data in the order for the update data to be stored in the transmission buffer that stores the update data to be transmitted to the receiving terminal, as comparison data; deleting the comparison data when determining that an update region of the comparison data recognized by the comparison-target recognizing section is included in an update region of newly-received update data by the receiver; and storing the newly-received update data in the transmission buffer.

An image-sharing controlling method according to a still further aspect of the invention is a method by a computer for displaying an image transmitted and received between a plurality of terminals connected to each other via a network includes: receiving update data from a transmitting terminal of the plurality of terminals, the update data including an update image of at least a part of an image currently displayed on the transmitting terminal and update region location information showing a location of an update region of the update image in the image; temporarily storing the update data in a transmission buffer; transmitting the update data stored in the transmission buffer to a receiving terminal of the plurality of terminals in the order for the update data to be stored to update the update region of the image currently displayed on the receiving terminal to the update image, the number of the receiving terminal being equal to that of the transmission buffer; requesting the transmitting terminal to transmit the update data of the entire region including the update image of the entire image when specifying the transmission buffer, in which the update data are stored over a threshold, as a threshold-exceeding buffer; deleting untransmitted update data stored in the threshold-exceeding buffer when the update data of the entire region are transmitted from the transmitting terminal as requested by the threshold excess judgment section; and storing the update data of the entire region in the threshold-exceeding buffer when the update data are deleted.

An image-sharing controlling program according to a still further aspect of the invention is a program for operating a computer to function as the above-described image-sharing controller.

An image-sharing controlling program according to a still further aspect of the invention is a program for operating a computer to execute the above-described image-sharing controlling method.

A recording medium according to a still further aspect of the invention is a recording medium on which the above-described image-sharing controlling program is recorded in a computer-readable manner.

### BRIEF DESCRIPTION OF DRAWINGS

FIG. 1 is a block diagram schematically showing an arrangement of an image-sharing system according to a first and second exemplary embodiments of the invention.

FIG. 2 schematically shows an arrangement of update data according to the first and second exemplary embodiments of the invention.

FIG. 3 schematically shows transmission and reception conditions of update images according to the first exemplary embodiment.

FIG. 4 schematically shows control conditions for storing an update image in a transmission buffer according to the first exemplary embodiment.

FIG. 5 is a block diagram schematically showing an arrangement of a server controller according to the first exemplary embodiment of the invention.

FIG. 6 schematically shows a setting processing of an optimum transmission band according to the first and second exemplary embodiments.

FIG. 7 is a flow chart showing a control processing for storing the update data according to the first exemplary embodiment.

FIG. 8 schematically shows how the update image in the transmission buffer is controllably stored when updating an entire region of the images according to the first exemplary embodiment.

FIG. 9 schematically shows a screen when updating entire region of the images according to the first exemplary embodiment.

FIG. 10 is a flow chart showing a regional update processing according to the first exemplary embodiment.

FIG. 11 schematically shows a screen when updating a part of the images according to the first exemplary embodiment.

FIG. 12 schematically shows a screen when updating a part of the images according to the first exemplary embodiment.

FIG. 13 schematically shows a screen when updating a part of the images according to the first exemplary embodiment.

FIG. 14 schematically shows a screen when updating a part of the images according to the first exemplary embodiment.

FIG. 15 schematically shows a screen when updating a part of the images according to the first exemplary embodiment.

FIG. 16 schematically shows a screen when updating a part of the images according to the first exemplary embodiment.

FIG. 17 schematically shows a screen when updating a part of the images according to the first exemplary embodiment.

FIG. 18 is a block diagram schematically showing an arrangement of a server controller according to the second exemplary embodiment of the invention.

FIG. 19 is a flow chart showing a control processing for storing the update data according to the second exemplary embodiment.

FIG. 20 schematically shows that a first threshold-exceeding buffer according to the second exemplary embodiment is specified.

FIG. 21 schematically shows that a second threshold-exceeding buffer according to the second exemplary embodiment is specified.

FIG. 22 schematically shows that candidate entire-region storage data are stored in the first and second threshold-exceeding buffers according to the second exemplary embodiment.

FIG. 23 is a flow chart showing a regional update processing according to a modification of the invention.

### EXPLANATION OF CODES

1, 7 Image-sharing system

2 Network

3 Image providing terminal as a transmitting terminal

4, 5 First and second image-receiving terminals as a receiving terminal

6, 8 Image-sharing server as an image-sharing controller

35, 45, 55 Terminal communication band controller as an optimum transmission band setting section

67 Server receiver

73, 83 Server controller (computer)

200 Updated data

201 Frame number information as display order information

203 Update region location information

711,721 First and second transmission buffers

712,722 First and second server transmitters

731 Candidate transmission-band setting section

732 Comparison-target recognizing section

733,833: Deletion controller

734,834: Storage controller

832: Threshold excess judgment section

G Image

H Update image

R Update region

### BEST MODE FOR CARRYING OUT THE INVENTION

An exemplary embodiment of the invention will be described with reference to the attached drawings.

This exemplary embodiment is exemplified by an image-sharing system by which an image currently displayed on a first terminal is displayed on a second terminal.

### First Exemplary Embodiment

[Arrangement of Image Sharing System]

An arrangement of an image-sharing system according to a first exemplary embodiment of the invention will be described.

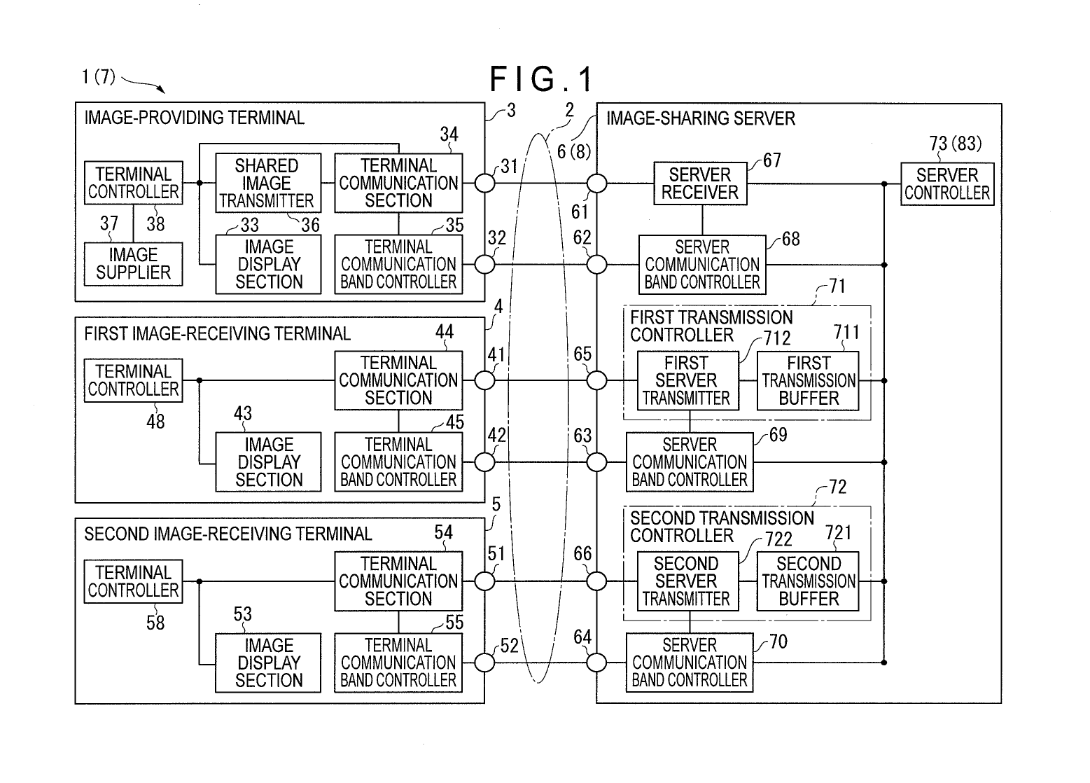

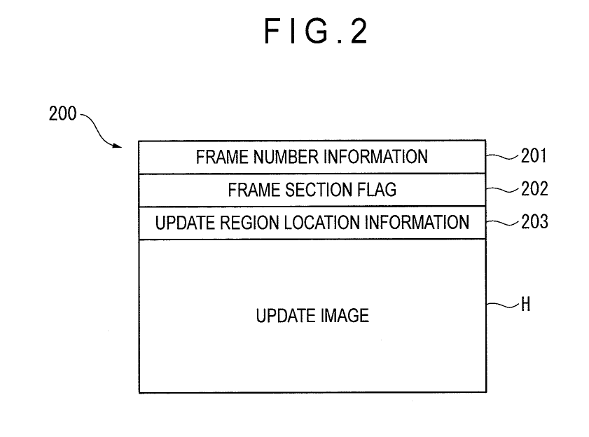

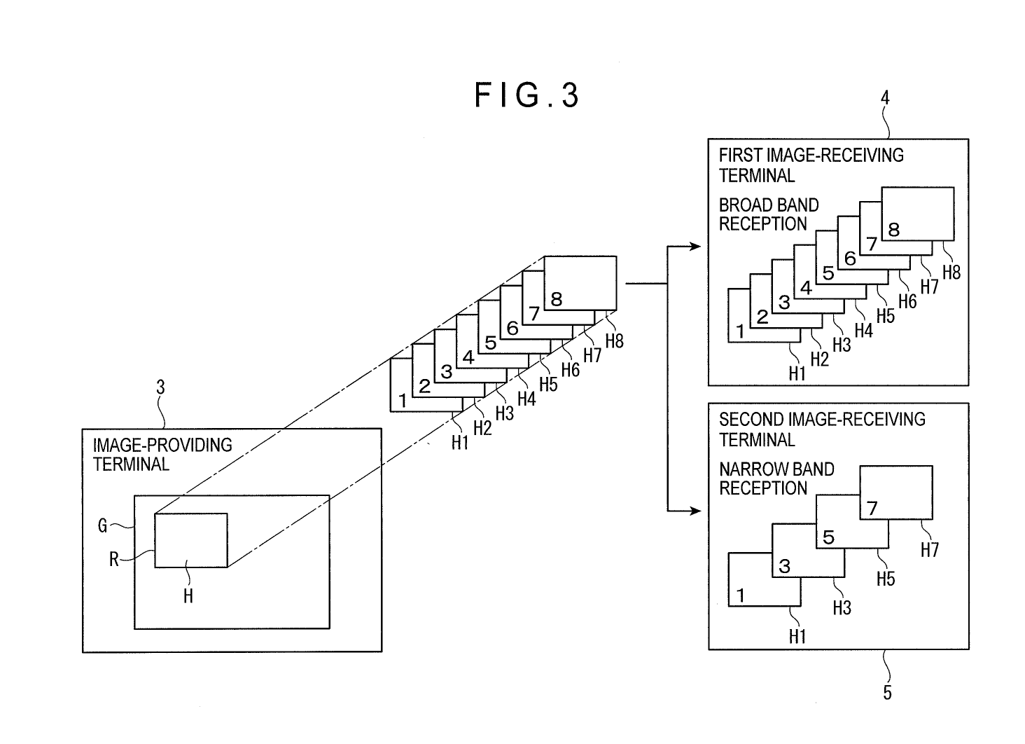

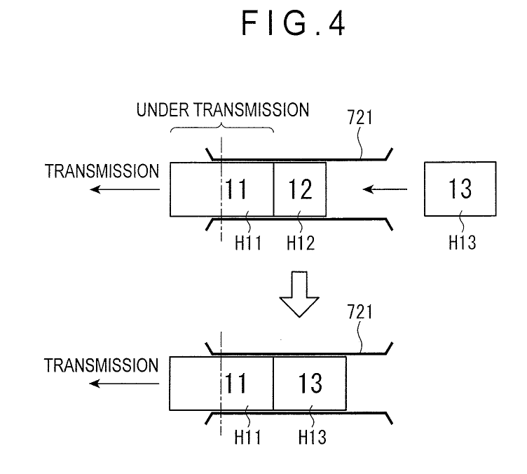

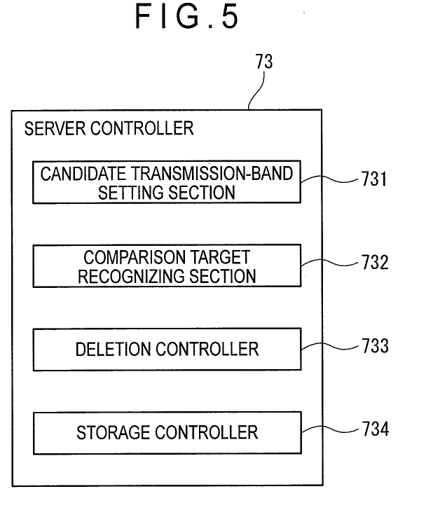

FIG. 1 is a block diagram schematically showing an arrangement of an image-sharing system according to the first exemplary embodiment and a second exemplary embodiment. FIG. 2 schematically shows an arrangement of update data. FIG. 3 schematically shows transmission and reception conditions of an update image. FIG. 4 schematically shows control conditions for storing the update image in a transmission buffer. FIG. 5 is a block diagram schematically showing an arrangement of a server controller.

As shown in FIG. 1, the image-sharing system 1 includes a network 2, an image-providing terminal 3 as a transmitting terminal, a first image-receiving terminal 4 as a receiving terminal, a second image-receiving terminal 5 as a receiving terminal, and an image-sharing server 6 as an image-sharing controller. In the first exemplary embodiment, a single image-receiving terminal may be provided. Alternatively, three or more image-receiving terminals may be provided.

Herein, when at least two terminals among the image-providing terminal 3 and the first and second image-receiving terminals 4 and 5 are collectively described, the two terminals are simply referred to as “terminals.”

The terminals 3 to 5 and the image-sharing server 6 are connected to the network 2. The network 2 connects between the terminals 3 to 5 and the image-sharing server 6 in a manner capable of transmitting and receiving information. The network 2 is exemplified by the internet based on versatile protocols such as TCP/IP, an intranet, LAN (Local Area Network), networks such as a communication line network and a broadcasting network provided by a plurality of base stations capable of transmitting and receiving information by wireless media, and wireless media itself serving as media for transmitting and receiving information between the terminals 3 5 to 5 and the image-sharing server 6. As the wireless media, any media such as radio waves, lights, sound waves and electromagnetic waves are applicable.

Examples of the terminals 3 to 5 are a desktop or portable personal computer, a PDA (Personal Digital Assistant) and a portable phone.

The image-providing terminal 3 transmits a currently displayed image G thereon (see FIG. 3) to the first and second image-receiving terminals 4 and 5 to display the image G on the first and second image-receiving terminals 4 and 5. When an update region R (see FIG. 3), which is at least a part of the image G, is updated to an update image H (see FIG. 3), the image-providing terminal 3 transmits the update image H to the first and second image-receiving terminals 4 and 5 as needed to update the update region R of the image G to the update image H, whereby the image G is shared between the first and second image-receiving terminals 4 and 5.

Herein, the update image H is transmitted and received by update data 200 as shown in FIG. 2. The update data 200 includes frame number information 201 as display order information, a frame section flag 202, update region location information 203, and the update image H.

The frame number information 201 stores frame numbers showing a display order of the image G including the update image H. In the frame section flag 202, “0” is recorded when the update image H is a part of the image G and “1” is recorded when the update image H is the entire image G. In the update region location information 203, a location of the undated region R of the update image H is recorded by using, for instance, coordinates.

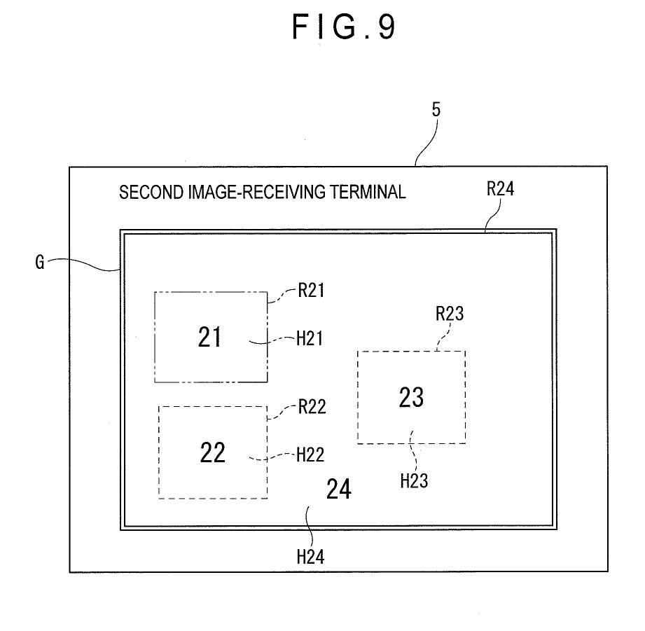

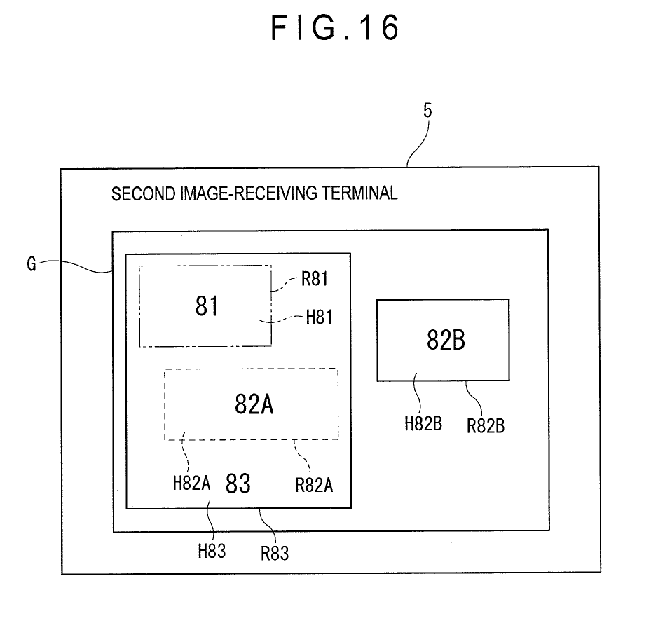

Hereinafter, the update image H and the update region R at an mth (m: natural number) frame number are respectively expressed as an update image Hm and an update region Rm (see, for instance, FIG. 9). Among a plurality of the update images H each having the same mth frame number and a different update region R, an update image H and update region R that are initially transmitted from the image-providing terminal 3 are respectively expressed as an update image HmA and an update region RmA. An update image H and update region R that are subsequently transmitted are respectively expressed as an update image HmB and an update region RmB (see, for instance, FIG. 16).

The image-providing terminal 3 includes an image-terminal transmission end-terminal 31, a terminal notification end-terminal 32, and an image display section 33. The controller 3 includes a terminal communication section 34, a terminal communication band controller 35 as an optimum transmission band setting section, a shared image transmitter 36, an image supplier 37, and a terminal controller 38. The above-listed components may be configured as programs.

The image display section 33 acquires the image G to be outputted from the terminal controller 38 and display the image G as shown in FIG. 3.

The terminal communication section 34 is controlled by the terminal communication band controller 35 to transmit the update data 200 acquired from the shared image transmitter 36 to the first and second image-receiving terminals 4 and 5 via the image-terminal transmission end-terminal 31 and the image-sharing server 6.

The terminal communication band controller 35 notifies a predetermined reception band to be set beforehand to the image-sharing server 6 via the terminal notification end-terminal 32. The terminal communication band controller 35 also receives a notification of a candidate transmission band that is set by the image-sharing server 6, via the terminal notification end-terminal 32. The terminal communication band controller 35 sets a narrower one of the candidate transmission band and a predetermined transmission band as an optimum transmission band and transmits the update data 200 from the terminal communication section 34 in the optimum transmission band.

The image supplier 37 is an application software for generating, for instance, a drawing and a document, or a software for reproducing video and images. The image supplier 37 sequentially outputs the image G to the terminal controller 38.

The terminal controller 38 operates the image display section 33 to display the image G outputted from the image supplier 37. When determining that continuously acquired images G are different, i.e., includes the update region R, the terminal controller 38 generates the update data 200. Specifically, the terminal controller 38 generates the update data 200 that includes the update image H of the update region R, the frame number information 201 on the frame number of the image G including the update image H, the frame section flag 202 showing whether the update region R covers the entire image G or not, and the update region location information 203 on the location of the update image H. Subsequently, the terminal controller 38 outputs the update data 200 to the terminal communication section 34 via the shared image transmitter 36.

The first and second image-receiving terminals 4 and 5 include terminal receiving end-terminals 41 and 51, terminal notification end-terminals 42 and 52, and image display sections 43 and 53. The first and second image-receiving terminals 4 and 5 include terminal communication sections 44 and 54, terminal communication band controllers 45 and 55 as the optimum transmission band setting section, terminal controllers 48 and 58. The above-listed components may be configured as programs.

The image display sections 43 and 53 acquire the image G and the update image H outputted from the terminal controllers 48 and 58 and operates a display region (not shown) to display the image G and the update image H.

The terminal communication sections 44 and 54 receive the update data 200 inputted via the terminal receiving end-terminals 41 and 51 in a predetermined reception band and outputs the update data 200 to the terminal controllers 48 and 58.

The terminal communication band controllers 45 and 55 notify the predetermined reception band to be set beforehand to the image-sharing server 6 via the terminal communication end-terminals 42 and 52. The terminal communication band controllers 45 and 55 also receive a notification of the candidate transmission band that is set by the image-sharing server 6, via the terminal notification end-terminals 42 and 52. The terminal communication band controllers 45 and 55 set a narrower one of the candidate transmission band and a predetermined transmission band as an optimum transmission band.

The terminal controllers 48 and 58 operate the image display sections 43 and 53 to display the image G that is acquired from the image-sharing server 6 via the terminal communication sections 44 and 54. Moreover, when acquiring the update data 200 from the image-providing terminal 3 via the image-sharing server 6, the terminal controllers 48 and 58 recognize a location of the update region R based on the update region location information 203. Subsequently, the terminal controllers 48 and 58 update the update region R of the currently displayed image G on the image display sections 43 and 53, to the update image H.

The image-sharing server 6 transmits and receives the image G and the update image H to be transmitted from the image-providing terminal 3 and operates the first and second image-receiving terminals 4 and 5 to display the image G and the update image H. The image-sharing server 6 also controls not to transmit a part of the update image H as needed when, for instance, transmission bands or reception bands of the terminals 3 to 5 are different. Such different transmission bands or reception bands are caused by, for instance, the difference in the predetermined transmission bands or predetermined reception bands of the terminals 3 to 5 and a failure of the network 2.

Specifically, as shown in FIG. 3, the image-sharing server 6 transmits all of the update image H1 to H8 to the first image-receiving terminal 4 having a broader reception band than the transmission band of the image-providing terminal 3, when the update images H1 to H8 are transmitted from the image-providing terminal 3. On the other hand, the image-sharing server 6 transmits the update images H1, H3, H5 and H7 but does not transmit the update images H2, H4, H6 and H8 to the second image-receiving terminal 5 having a narrower reception band than the transmission band of the image-providing terminal 3.

As shown in FIG. 1, the image-sharing server 6 includes a server receiving end-terminal 61, server notification end-terminals 62 to 64, server transmission end-terminals 65 and 66, a server receiver 67, server communication band controllers 68 to 70, first and second transmission controllers 71 and 72, and a server controller 73 (computer).

The server receiver 67 acquires the update data 200 from the image-providing terminal 3 via the server receiving end-terminal 61 and outputs the update data 200 to the server controller 73.

The server communication band controllers 68 to 70 acquire notifications of the predetermined reception bands of the terminals 3 to 5 via the server notification end-terminals 62 to 64 and the terminal notification end-terminals 32, 42 and 52, and output contents of the notifications to the server controller 73. When acquiring information on the candidate transmission bands from the server controller 73, the server communication band controllers 68 to 70 notify the information to the terminals 3 to 5.

First and second transmission controllers 71 and 72 include first and second transmission buffers 711 and 721, and first and second server transmitters 712 and 722.

The first and second transmission buffers 711 and 721 temporarily store the update data 200 outputted from the server controller 73 and output the stored update data 200 to the first and second server transmitters 712 and 722 in the order for the update data 200 to be stored.

The first and second server transmitters 712 and 722 are controlled by server communication band controllers 69 and 70 and transmit the update data 200, which are outputted from the first and second transmission buffers 711 and 721, in the predetermined reception bands of the first and second image-receiving terminals 4 and 5.

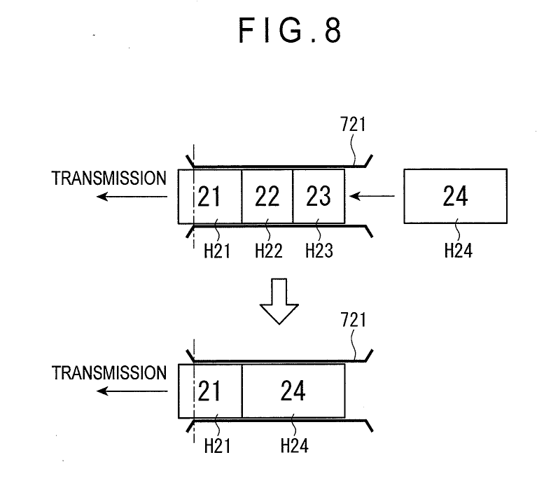

As shown in FIG. 4, in order to newly store an update image H13 when an update image H11 is being transmitted and an update image H12 is stored in, for instance, the second transmission buffer 721, the server controller 71 deletes the update image H12 and stores the update image H13 as needed when determining that an update region R12 of the update image H12 is included in the update region R13 of the update image H13. Although only the update image H is shown in FIG. 4 and later-described FIG. 8 and FIGS. 20 to 22, practically, the update data 200 including the update image H are stored and transmitted.

As shown in FIG. 5, the server controller 73 includes a candidate transmission-band setting section 731, a comparison-target recognizing section 732, a deletion controller 733, and a storage controller 734. The above-listed components may be configured as programs.

The candidate transmission-band setting section 731 receives the notifications of the predetermined reception bands in the terminals 3 to 5. As a candidate transmission band for each one of the terminals 3 to 5, the candidate transmission-band setting section 731 sets the broadest one of the predetermined reception bands of the other terminals. Subsequently, the candidate transmission-band setting section 731 notifies the candidate transmission bands, which are set respectively for the terminals 3 to 5, to the terminals 3 to 5.

The comparison-target recognizing section 732 specifies, as comparison data 200, the update data 200 to be possibly deleted by the deletion controller 733 among the update data 200 stored in the first and second transmission buffers 711 and 721.

When determining that the update region R of the comparison data 200 recognized by the comparison-target recognizing section 732 is included in the update region R of the update data 200 newly received by the server receiver 67 (hereinafter, referred to as candidate storage data 200), the deletion controller 733 deletes the comparison data 200 from the first and second transmission buffers 711 and 721.

The storage controller 734 stores the update data 200, which are received by the server receiver 67, in both the first and second transmission buffers 711 and 721. After the comparison data 200 are deleted in the deletion controller 733, the storage controller 734 stores the candidate storage data 200.

Although not shown in FIG. 1, the image-sharing system 1 is arranged so as to transmit the update data 200 from the first image-receiving terminal 4 and the second image-receiving terminal 5 to share the image G between the terminals 3 to 5.

[Operation of Image Sharing System]

Next, an operation of the image-sharing system 1 will be described.

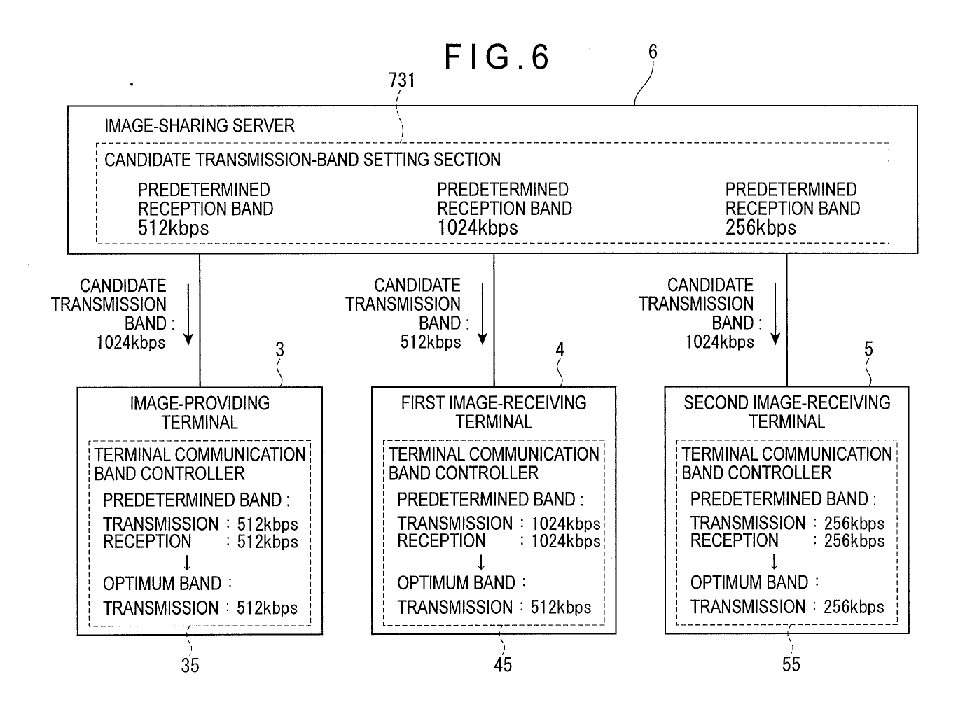

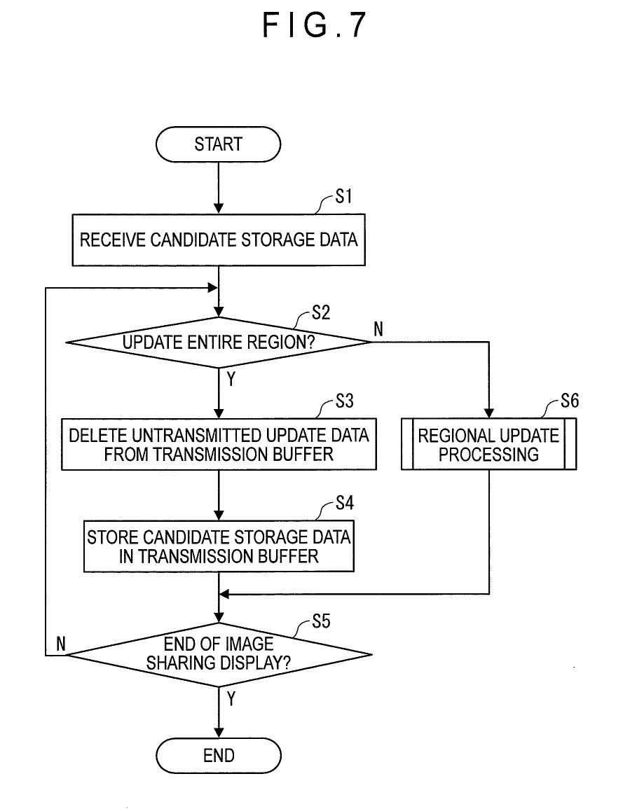

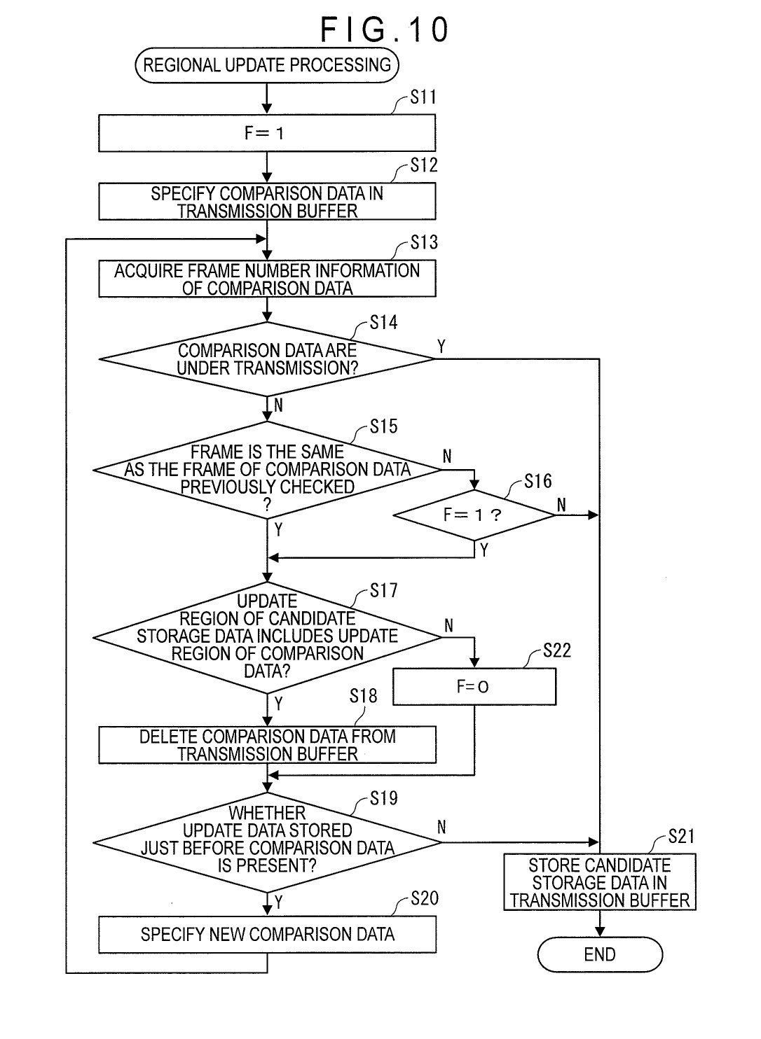

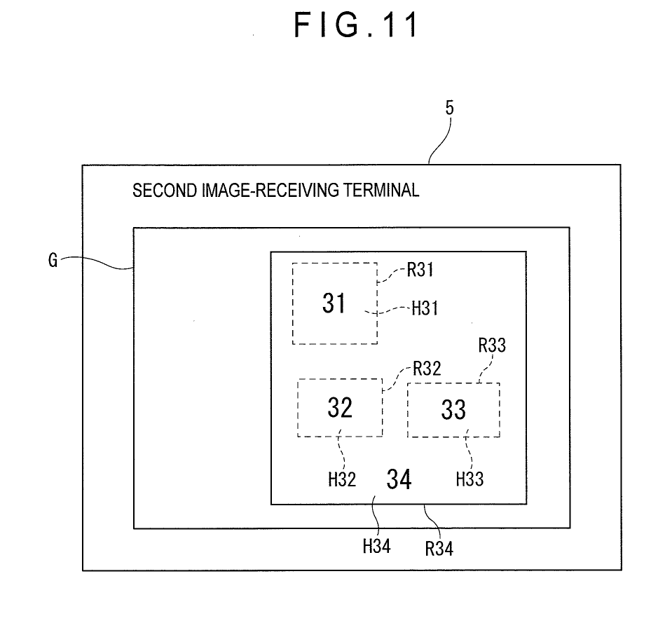

FIG. 6 schematically shows a setting processing of the optimum transmission band. FIG. 7 is a flow chart showing a storage control processing of the update data. FIG. 8 schematically shows control for storing the update image in the transmission buffer in order to update entire region of the images. FIG. 9 schematically shows a screen when updating the entire region of the image. FIG. 10 is a flow chart showing a regional update processing. FIGS. 11 to 17 schematically shows a screen when updating a part of the images.

(Setting Processing of Optimum Transmission Band)

The image-sharing server 6 of the image-sharing system 1 performs the setting processing of the optimum transmission band before starting a shared display of the image G.

Specifically, the candidate transmission-band setting section 731 of the image-sharing server 6 receives the notifications of the predetermined reception bands from the terminal communication band controllers 35, 45 and 55 of the terminals 3 to 5 via the server communication band controllers 68 to 70. As a candidate transmission band for each one of the terminals 3 to 5, the candidate transmission-band setting section 731 sets the broadest one of the reception bands of the other terminals. Then, the candidate transmission-band setting section 731 notifies the candidate transmission bands to each of the terminals 3 to 5.

For instance, in the predetermined reception bands as shown in FIG. 6, when receiving notifications that the predetermined reception bands of the terminals 3 to 5 are respectively 512 kbps, 1024 kbps, and 256 kbps, the candidate transmission-band setting section 731 sets the candidate transmission bands for the image-providing terminal 3, the first image-receiving terminal 4 and the second image-receiving terminal 5 respectively to be 1024 kbps, 512 kbps and 1024 kbps.

Subsequently, when receiving the notifications of the candidate transmission bands, the terminal communication band controllers 35, 45 and 55 of the terminals 3 to 5 set the narrower band among the candidate transmission band and the predetermined transmission band as the optimum transmission band.

For instance, in the predetermined transmission band as shown in FIG. 6, the terminal communication band controller 35 sets 512 kbps, which is the narrower band among the candidate transmission band (1024 kbps) and the predetermined transmission band (512 kbps), as the optimum transmission band. Likewise, the terminal communication band controllers 45 and 55 respectively set 512 kbps and 256 kbps as the optimum transmission band.

The image-sharing system 1 receives the update data 200 that are transmitted from the image-providing terminal 3 in the optimum transmission band and transmits the update data 200 to the first and second image-receiving terminals 4 and 5, thereby operating the terminals 3 to 5 to display the image G.

(Storage Control Processing of Updated Data)

The image-sharing server 6 of the image-sharing system 1 performs the storage control processing of the update data 200 in order to minimize a display time lag of the image G in the terminals 3 to 5. Herein, the storage control processing when the predetermined reception band of the second image-receiving terminal 5 is narrower than the optimum transmission band of the image-providing terminal 3 will be exemplarily described.

Specifically, as shown in FIG. 7, while the image G is shared between the terminals 3 to 5 and displayed therein, the server controller 73 of the image-sharing server 6 receives the candidate storage data 200 that are transmitted from the image-providing terminal 3 in the optimum transmission band, by the storage controller 734 (Step S1). Subsequently, based on the frame section flag 202 of the candidate storage data 200, the deletion controller 733 of the server controller 73 judges whether the update image H covers the entire image or not, in other words, whether to update the entire region of the image G currently displayed on the second image-receiving terminal 5 (Step S2). When determining that the entire region is to be updated in Step S2, the deletion controller 733 deletes the untransmitted update data 200 from the second transmission buffer 721 (Step S3). The storage controller 734 stores the candidate storage data 200 in the second transmission buffer 721.

For instance, as shown in FIG. 8, a currently-transmitted update image H21 and untransmitted update images H22 and H23 are stored in the second transmission buffer 721. When the storage controller 734 newly receives an update image H24 that covers the entire image H, the storage controller 734 deletes only the update images H22 and H23 and stores the update image H24. By this processing, as shown in FIG. 9, after an update region R21 of the image H is updated to the update image H21 shown in a chain double-dashed line in the second image-receiving terminal 5, update regions R22 and R23 are not updated to the update images H22 and H23 shown in dashed lines, but the update region R24 is updated to the update image H24 shown in a solid line.

After the processing of Step S4, the storage controller 734 judges whether a shared display processing of the image G is terminated or not (Step S5). When determining that the shared display processing is terminated in Step S5, the storage control processing is to be terminated. When judging that the shared display processing is not terminated, the processing of S2 is to be performed.

When determining that a region of the image G is to be updated in Step S2, the comparison-target recognizing section 732 of the server controller 73 performs a regional update processing (Step S6), whereby the storage controller 734 performs the processing of Step S5.

As shown in FIG. 10, in the regional update processing in Step S6, the comparison-target recognizing section 732 sets a judgment flag F at “1” (Step S11) and specifies the update data 200 last stored in the second transmission buffer 721 as the comparison data 200 (Step S12).

When there are a plurality of the update data 200 each including a plurality of the update image H having the same frame number and a different update region R, and all of the plurality of the update data 200 are deleted from the second transmission buffer 721, the judgment flag remains “1” without change. On the other hand, when at least one of the plurality of the update data 200 is not deleted, the judgment flag F is changed to “0.”

Then, the comparison-target recognizing section 732 acquires the frame number information 201 of the comparison data 200 (Step S13) and judges whether the comparison data 200 is being transmitted or not (Step S14).

When determining that the comparison data 200 is not being transmitted in Step S14, based on the frame number information 201 acquired in Step S13, the comparison-target recognizing section 732 judges whether the comparison data 200 has the same frame number (i.e., the same frame) as previously checked comparison data 200. When determining that the comparison data 200 has a different frame from the previously checked comparison data 200, the comparison-target recognizing section 732 judges whether the judgment flag F is “1” or not (Step S16). When determining that the judgment flag F is “1” in the comparison-target recognizing section 732, in other words, that all the comparison data 200 having the same frame number as the previously checked comparison data 200 are deleted in Step S16, the deletion controller 733 judges whether the update region R of the candidate storage data 200 includes the update region of the comparison data 200 (Step S17).

When determining that the update region R of the candidate storage data 200 includes the update region of the comparison data 200, the deletion controller 733 deletes the comparison data 200 from the second transmission buffer 721 (Step S18). The comparison-target recognizing section 732 judges whether the update data 200 stored just before the comparison data 200 remain or not (Step S19). When determining that the update data 200 remains in Step S19, the comparison-target recognizing section 732 specifies the update data 200 as new comparison data 200 (Step S20) and the processing of S13 is performed.

When determining by the comparison-target recognizing section 732 in Step S14 that the comparison data 200 is being transmitted, or determining that no update data 200 remains in Step S19, the server controller 73 stores the candidate storage data 200 in the second transmission buffer 721 by the storage controller 734 (Step S21). Thus, the regional update processing is to be terminated.

When the server controller 73 determines by the comparison-target recognizing section 732 in Step S15 that the comparison data 200 have the same frame as the previously checked comparison data 200, the processing of Step S17 is performed.

When determining by the deletion controller 733 in Step S17 that the update region R of the candidate storage data 200 does not include the update region of the comparison data 200, the server controller 73 operates the comparison-target recognizing section 732 to set the judgment flag F at “0” (Step S22) and the processing of Step S19 is performed.

When determining by the comparison-target recognizing section 732 that the judgment flag F is “0”, i.e., that at least one of the comparison data 200 having the same frame number as the previously checked comparison data 200 is not deleted in Step S16, the server controller 73 performs the processing of Step S21 through storage controller 734 to store the candidate storage data 200.

By the above regional update processing, the image G is updated in the second image-receiving terminal 5 as shown in FIGS. 11 to 17.

When an update image H34 is received while update images H31 to H33 are not transmitted from the image-sharing server 6, as shown in FIG. 11, the processings of Steps S13 to S20 are repeated three times, whereby the update images H31 to H33 are deleted and the update image H34 is stored by the processing of Step S21. Then, without updating update regions R31, R32 and R33 of the image G to the update images H31, H32 and H33 shown in dotted lines, the update region R34 is updated to the update image H34 shown in a solid line.

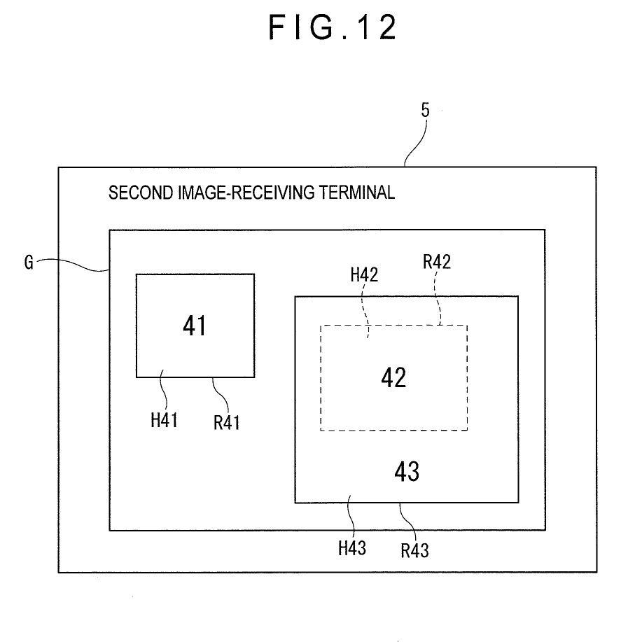

When an update image H43 is received while update images H41 and H42 are not transmitted from the image-sharing server 6, as shown in FIG. 12, the processings of Steps S13 to S20 are performed once, whereby only the update image H42 is deleted and the update image H43 is stored just after the update image H41 by the processings of Steps S13 to S17, S22, S19 and S21. After an update region R41 of the image G is updated to the update image H41 shown in a solid line, without updating an update region R42 to the update image H42 shown in a dotted line, an update region R43 is updated to the update image H43 shown in a solid line.

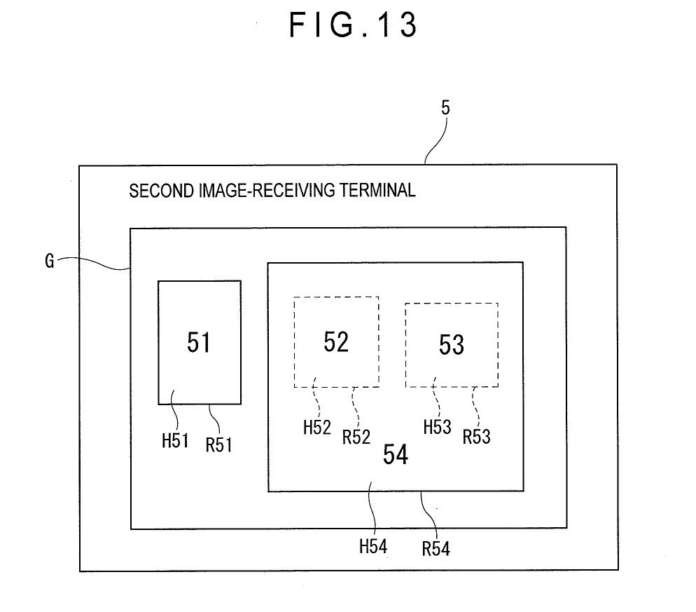

When an update image H54 is received while update images H51 to H53 are not transmitted from the image-sharing server 6, as shown in FIG. 13, the processings of Steps S13 to S20 are repeated twice, whereby the update images H52 and H53 are deleted and the update image H54 is stored just after the update image H51 by the processings of Steps S13 to S17, S22, and S19 to S21. After an update region R51 of the image G is updated to the update image H51 shown in a solid line, without updating update regions R52 and R53 to the update images H52 and H53 shown in a dotted line, an update region R54 is updated to the update image H54 shown in a solid line.

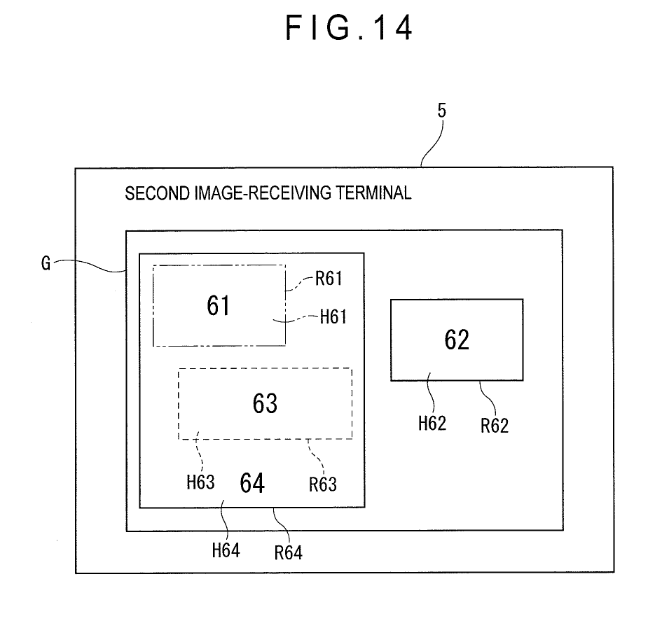

When an update image H64 is received while update images H61 to H63 are not transmitted from the image-sharing server 6, as shown in FIG. 14, the processings of Steps S13 to S20 are performed once, whereby the update image H63 is deleted and the update image H64 is stored just after the update image H62 by the processings of Steps S13 to S17, S22, S19, S20, S13 to S16 and S21. After an update region R61 of the image G is updated to the update image H61 shown in a chain double-dashed line and an update region R62 is updated to the update image H62 shown in a solid line, without updating an update region R63 to the update image H63 shown in a dotted line, an update region R64 including the update regions R61 and R63 is updated to the update image H64 shown in a solid line.

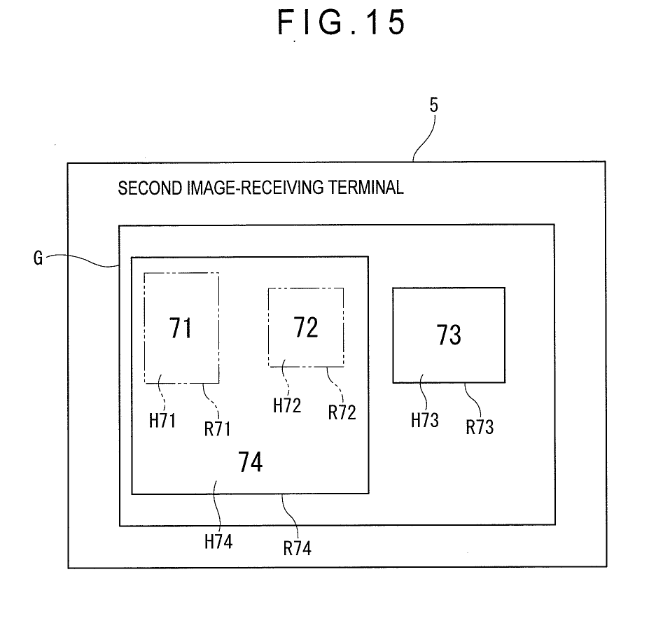

When an update image H74 is received while update images H71 to H73 are not transmitted from the image-sharing server 6, as shown in FIG. 15, the processings of Steps S13 to S17, S22, S19, S20, S13 to S16 and S21 are performed, and the update image H74 is stored just after the update image H73 without deleting the update images H71 to H73. After update regions R71 and R72 of the image G are updated to the update images H71 and H72 shown in a chain double-dashed line and an update region R73 is updated to the update image H73 shown in a solid line, an update region R74 including the update regions R71 and R72 is updated to the update image H74 shown in a solid line.

When an update image H83 is received while update images H81, H82A and H82B are not transmitted from the image-sharing server 6, as shown in FIG. 16, the update image H82B is not deleted by the processings of S13 to S17, S22, S19 and S20; the update image H82A is deleted by the processings of Steps S13 to S15 and S17 to S20; the update image H81 is not deleted by the processings of Steps S13 to S16 and S21; and the update image H83 is stored just after the update image H82B. After an update region R81 of the image G is updated to the update image H81 shown in a chain double-dashed line and an update region R82B is updated to the update image H82B shown in a solid line without updating an update region R82A to the update image H82A shown in a dotted line, an update region R83 including the update regions R81 and R82A is updated to the update image H83 shown in a solid line.

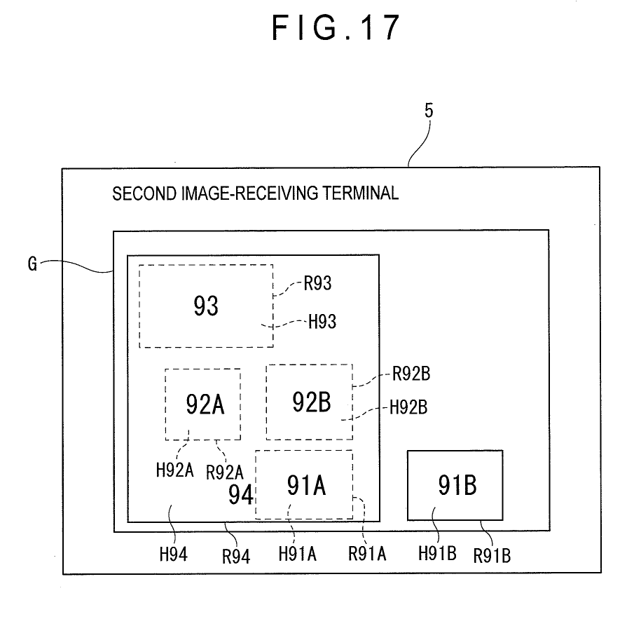

When an update image H94 is received while update images H91A, H91B, H92A, H92B and H93 are not transmitted from the image-sharing server 6, as shown in FIG. 17, the update images H93,H92B are deleted by repeating the processings of S13 to S20 twice; the update image H92A is deleted by the processings of Steps S13 to S15 and S17 to S20; the update image H91B is not deleted by the processings of Steps S13 to S17, S22, S19 and S20; and the update image H94 is stored just after the update image H91B. After an update region R91B of the image G is updated to the update image H92B shown in a solid line, without updating update regions R91A, R92A, R92B and R93 to the update images H91A, H92A, H92B and H93 shown in a dotted line, an update region R94 including the update regions R91A, R92A, R92B and R93 is updated to the update image H94 shown in a solid line.

### Advantages of First Exemplary Embodiment

The image-sharing system according to the first exemplary embodiment as described above offers the following advantages.

(1) When acquiring by the server controller 73 the candidate storage data 200 including the update image H of the image G currently displayed on the image-providing terminal 3 when, for instance, the predetermined reception band of the second image-receiving terminal 5 is narrower than the optimum transmission band of the image-providing terminal 3, the image-sharing server 6 of the image-sharing system 1 specifies the last update data 200 in the order for the update data 200 to be stored in the second transmission buffer 721 as the comparison data 200. Further, when determining that the update region of the comparison data 200 is included in the update region R of the candidate storage data 200, the server controller 73 deletes the comparison data 200 and stores the candidate storage data 200 in the second transmission buffer 721. The server controller 73 transmits the update data 200 of the second transmission buffer 721 to the second image-receiving terminal 5 in the order for the update data 200 to be stored to update the image G currently displayed on the second image-receiving terminal 5 to the update image H.

Thus, the comparison data 200 having an update region duplicating that of the update image H of the candidate storage data 200 are deleted and not transmitted, and the to-be-transmitted update data 200 are transmitted to the second image-receiving terminal 5 without deterioration of an image quality of the update image H included in the to-be-transmitted update data 200. Accordingly, the currently displayed image G on the second image-receiving terminal 5 can be updated without deterioration of an image quality. Moreover, since an update image of a part of the comparison data 200 is not transmitted to the second image-receiving terminal 5, a display time lag generated between the image-providing terminal 3 and the second image-receiving terminal 5 can be minimized. Particularly in the images such as drawings and documents to be displayed on a personal computer, an image quality is important and a movement is less important. Accordingly, the image-sharing system 1 according to this exemplary embodiment is efficiently usable. Consequently, the image-sharing system 1 can be provided that enables the image G currently displayed on the image-providing terminal 3 to be suitably displayed even on the second image-receiving terminal 5 having a different communication band.

(2) After deleting the comparison data 200, the server controller 73 specifies the last update data 200 in the order for the data 200 to be stored, as new comparison data 200. When an update region of the new comparison data 200 is included in the update region of the candidate storage data 200, the comparison data 200 are deleted.

Accordingly, the display time lag between the image-providing terminal 3 and the second image-receiving terminal 5 can be further reduced.

(3) The server controller 73 specifies as the comparison data 200 the update data 200 having the same frame number as the last update data 200 in the order for the update data 200 to be stored in the second transmission buffer 721. When at least one of the update regions of the comparison data 200 duplicates those of the candidate storage data 200, the server controller 73 deletes this duplicating comparison data 200.

Accordingly, even when the update data 200 are not last in the order for the update data to be stored, the update data 200 have the same frame number as the last update data 200 in the order for the update data to be stored and have an update region duplicating that of the candidate storage data 200, the update data 200 can be deleted, so that a display time lag can be reduced. This arrangement is efficient particularly in dark scenes and animations where a plurality of regions positioned separately from each other may be updated at the same time.

(4) When deleting all the comparison data 200 having the same frame number, the server controller 73 specifies as new comparison data 200 the update data 200 having a frame number just before that of the comparison data 200. When not deleting at least one of the comparison data 200 having the same frame number, the server controller 73 stores the candidate storage data 200 without specifying new comparison data 200.

Accordingly, the comparison data 200 can be efficiently deleted without changing a display order based on the frame numbers, so that a display time lag can be reduced.

(5) When the update image H of the candidate storage data 200 covers the entire image G, the server controller 73 deletes all the untransmitted update data 200 stored in the second transmission buffer 721 and stores the candidate storage data 200.

Accordingly, the candidate storage data 200 and all the update data 200 in the second transmission buffer 721 are not sequentially compared to each other, so that a deletion control processing can be efficient and a display time lag can be reduced.

(6) The server controller 73 sets the broader one of the predetermined reception bands of the first and second image-receiving terminals 4 and 5 as a candidate transmission band and notifies the candidate transmission band to the image-providing terminal 3. The image-providing terminal 3 sets as an optimum transmission band a narrower one of the predetermined transmission band and the candidate transmission band and transmits the update data 200 in the optimum transmission band.

When the narrower one of the predetermined reception bands of the first and second image-receiving terminals 4 and 5 is set as the candidate transmission band, the update data 200 is transmitted to the terminal having the broader predetermined reception band in the narrower reception band, so that an updating speed may be slowed down. In contrast, by setting the broader band as the candidate transmission band, the images can be displayed on the terminal having the broader predetermined reception band without slowing the updating speed.

### Second Exemplary Embodiment

[Arrangement of Image Sharing System]

Nest, an arrangement of an image-sharing system according to a second exemplary embodiment of the invention will be described.

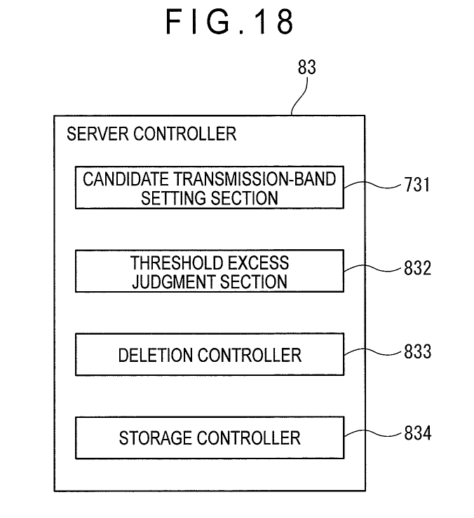

FIG. 18 is a block diagram schematically showing an arrangement of a server controller.

As shown in FIG. 1, an image-sharing system 7 has the same arrangement as the image-sharing system 1 of the first exemplary embodiment except for that an image-sharing server 8 is used in place of the image-sharing server 6 of the first exemplary embodiment as an image-sharing controller.

In the second exemplary embodiment, a plurality of (three or more) image-receiving terminals may be provided.

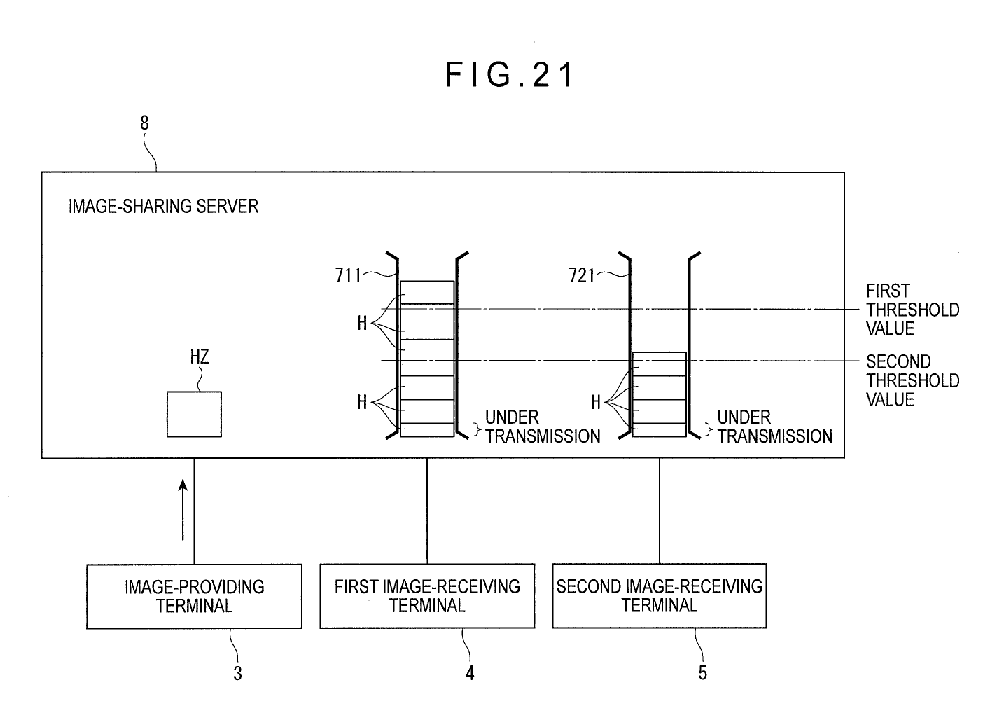

The image-sharing server 8 transmits and receives the image G and the update image H to be transmitted from the image-providing terminal 3 and operates the first and second image-receiving terminals 4 and 5 to display the image G and the update image H. When the transmission bands or the reception bands of the terminals 3 to 5 are different, the image-sharing server 8, as needed, deletes all the untransmitted update data 200 that are stored in the first and second transmission buffers 711 and 721, and acquires an entire update image HZ (see FIG. 21), which is the image G of an entire frame, from the image-providing terminal 3 to transmit the entire update image HZ to the first and second image-receiving terminals 4 and 5.

The image-sharing server 8 has the same arrangement as the image-sharing server 6 of the first exemplary embodiment except that a server controller 83 (computer) is used in place of the server controller 73 of the first exemplary embodiment.

As shown in FIG. 18, the server controller 83 includes the candidate transmission-band setting section 731, a threshold excess judgment section 832, a deletion controller 833, and a storage controller 834. The above-listed components may be configured as programs.

The threshold excess judgment section 832 specifies the first and second transmission buffers 711 and 721 as a first threshold-exceeding buffer, in which storage amounts of the update data 200 exceed a first threshold value. The threshold excess judgment section 832 also specifies the first and second transmission buffers 711 and 721 as a second threshold-exceeding buffer, in which storage amounts of the update data 200 exceed a second threshold value smaller than the first threshold value.

The first and second threshold values may be the same as or different from each other in first and second transmission buffers 711 and 721. The first and second threshold values may be exemplarily set at different values according to the following formula (1).

(Formula 1)

X=Y×Z (1)

X: First threshold value

Y: Optimum transmission band in the image-receiving terminal

Z: Allowable time for transmission delay

According to the formula (1), when, for instance, the optimum transmission band of the first image-receiving terminal 4 is 512 kbps and an allowable time for maximum transmission delay is 20 seconds, the first threshold value is set at 1280 kByte (10240 kbit).

After specifying the first threshold-exceeding buffer, the threshold excess judgment section 832 requests the image-providing terminal 3 to transmit the update data 200 of the entire region including the entire update image HZ of the entire image G (hereinafter, referred to as candidate entire-region storage data 200).

When the candidate entire-region storage data 200 are transmitted from the image-providing terminal 3, the deletion controller 833 deletes all the untransmitted update data 200 from the first and second threshold-exceeding buffers.

The storage controller 834 stores the newly-received update data 200 in both the first and second transmission buffers 711 and 721. The storage controller 834 also stores the candidate entire-region storage data 200 requested by the threshold excess judgment section 832 only in the first and second threshold-exceeding buffers. For instance, when the first transmission buffer 711 corresponds to the first threshold-exceeding buffer and the second transmission buffer 721 does not correspond to the first and second threshold-exceeding buffers, the candidate entire-region storage data 200 are stored in the first transmission buffer 711, but not in the second transmission buffer 721.

[Operation of Image Sharing System]

Next, an operation of the image-sharing system 7 will be described.

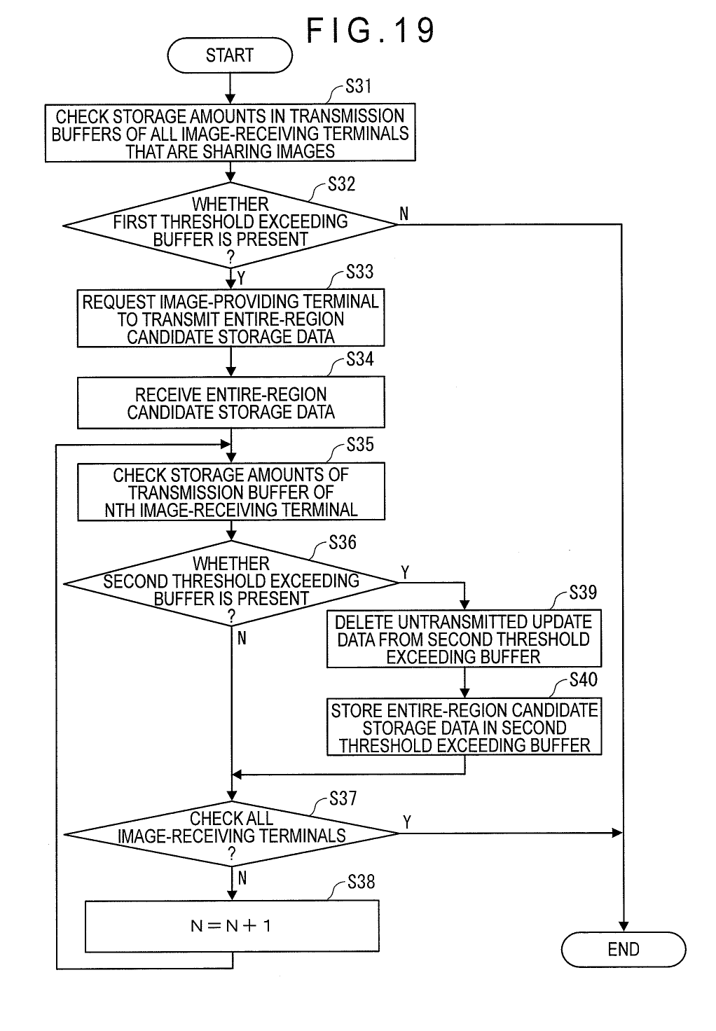

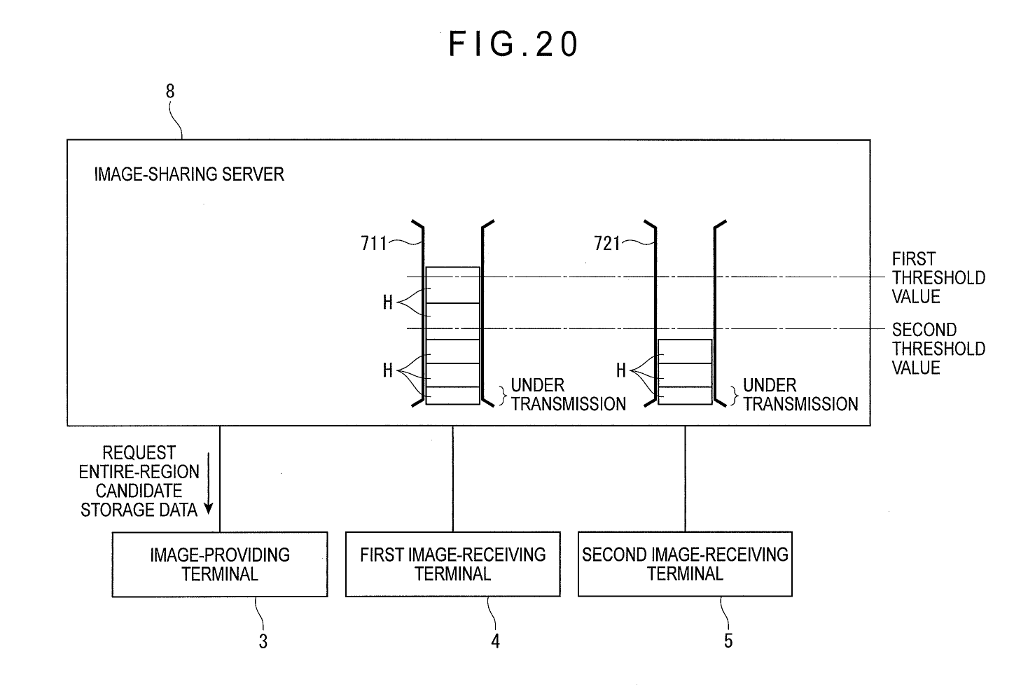

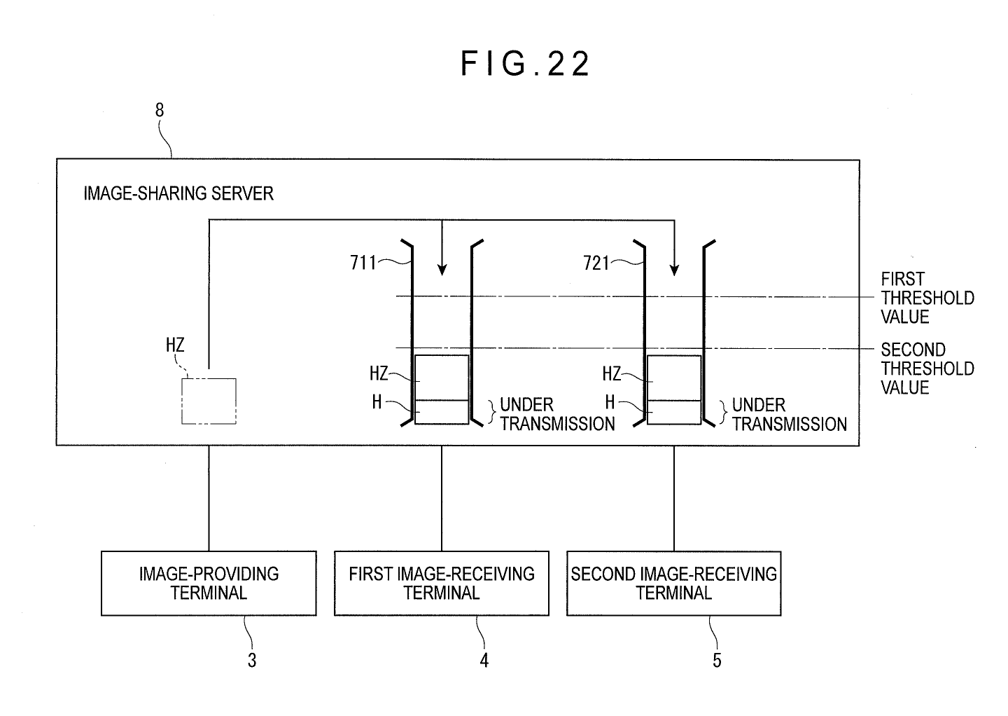

FIG. 19 is a flow chart showing a storage control processing of the update data. FIG. 20 schematically shows a state where the first threshold-exceeding buffer is specified. FIG. 21 schematically shows a state where the second threshold-exceeding buffer is specified. FIG. 22 schematically shows a state where the candidate entire-region storage data are stored in the first and second threshold-exceeding buffers.

(Setting Processing of Optimum Transmission Band)

Before starting a shared display of the image G, the image-sharing server 8 of the image-sharing system 7 performs the setting processing of the optimum transmission band in the same manner as the image-sharing server 6 of the first exemplary embodiment.

(Storage Control Processing of Updated Data)

The image-sharing server 8 of the image-sharing system 7 performs the storage control processing of the update data 200 in order to minimize a display time lag of the image G in the terminals 3 to 5. Herein, it is exemplarily presumed that both the first threshold values and the second threshold values for the first and second transmission buffers 711 and 721 are set to be the same.

Specifically, while the image G is shared between the terminals 3 to 5 and displayed thereon, the server controller 83 of the image-sharing server 8, as shown in FIG. 19, checks the storage amounts in the first and second transmission buffers 711 and 721 that store the update data 200 to be transmitted to the first and second image-receiving terminals 4 and 5 (all the image-receiving terminals) currently sharing the image (Step S31), and judges whether the first threshold-exceeding buffer is present or not (Step S32), by the threshold excess judgment section 832.

When determining that the first threshold-exceeding buffer is not present in Step S32, the server controller 83 of the image-sharing server 8 terminates the storage control processing. When determining that the first threshold-exceeding buffer is present in Step S32, the server controller 83 of the image-sharing server 8 requests the image-providing terminal 3 to transmit the candidate entire-region storage data 200 (Step S33). As shown in FIG. 20, for instance, when the storage amounts of the update data 200 (only the update image H is shown in FIGS. 20 to 22) of the first transmission buffer 711 exceed the first threshold value, the threshold excess judgment section 832 specifies the first transmission buffer 711 as the first threshold-exceeding buffer and requests the candidate entire-region storage data 200.

Subsequently, as shown in FIG. 19, the storage controller 834 of the server controller 83 receives the candidate entire-region storage data 200 including the entire update image HZ of the entire image G (Step S34).

As shown in FIG. 21, other update data 200 transmitted from the image-providing terminal 3 after requesting and before receiving the candidate entire-region storage data 200 are, stored in the first and second transmission buffers 711 and 721. Accordingly, when the candidate entire-region storage data 200 are received, the storage amounts in the first and second transmission buffers 711 and 721 may be larger than those before the transmission of the candidate entire-region storage data 200 is requested.

The threshold excess judgment section 832 checks a storage amount of a transmission buffer of an Nth (N: natural number) image-receiving terminal (Step S35), and judges whether the transmission buffer is the second threshold-exceeding buffer or not (Step S36).

In Step S36, when determined to be the first threshold-exceeding buffer in Step S32, the transmission buffer is specified as the second threshold-exceeding buffer. For instance, as shown in FIGS. 20 and 21, the first transmission buffer 711 exceeding the first threshold value is specified as the second threshold-exceeding buffer. Moreover, when the transmission buffer is not determined as the first threshold-exceeding buffer in Step S32 but exceeds the first or second threshold value by other update data 200 being stored after the candidate entire-region storage data 200 are requested to be transmitted, the transmission buffer is specified as the second threshold-exceeding buffer. For instance, the second transmission buffer 721, which does not exceed the first threshold value in Step S32 as shown in FIG. 20, but exceeds the second threshold value after the request of the candidate entire-region storage data 200 as shown in FIG. 21, is also specified as the second threshold-exceeding buffer.

When determining that the transmission buffer is not the second threshold-exceeding buffer in Step S36, the threshold excess judgment section 832 judges whether all the image-receiving terminals are checked or not (Step S37). When determining that all the image-receiving terminals are checked, the threshold excess judgment section 832 terminates the storage control processing. On the contrary, when determining that checking of all the image-receiving terminals is not finished, the threshold excess judgment section 832 adds 1 to a variable N (Step S38) and performs the processing of Step S35.

When determining that the transmission buffer is the second threshold-exceeding buffer by the threshold excess judgment section 832 in Step S36, the server controller 83 deletes the untransmitted update data 200 from the second threshold-exceeding buffer in the deletion controller 833 (Step S39). The storage controller 83 stores the candidate entire-region storage data 200 in the second threshold-exceeding buffer by the storage controller 834 and performs the processing of Step S37.

### Advantages of Second Exemplary Embodiment

In the image-sharing system 7 of the second exemplary embodiment as described above, the following advantages can be obtained in addition to the advantages (6) of the first exemplary embodiment.

(7) For instance, when the storage amounts of the first transmission buffer 711 exceed the first threshold value, the image-sharing server 8 of the image-sharing system 7 specifies the first transmission buffer 711 as the first threshold-exceeding buffer by the server controller 83 and requests the image-providing terminal 3 to transmit the candidate entire-region storage data 200 including the entire update image HZ. After receiving the candidate entire-region storage data 200, the image-sharing server 8 of the image-sharing system 7 deletes the untransmitted update data 200 from the first threshold-exceeding buffer and stores the candidate entire-region storage data 200. Subsequently, the image-sharing server 8 of the image-sharing system 7 transmits the candidate entire-region storage data 200 of the first threshold-exceeding buffer to the first image-receiving terminal 4 to update the image G currently displayed on the first image-receiving terminal 4 to the entire update image HZ.

Thus, the candidate entire-region storage data 200 are transmitted to the first image-receiving terminal 4 without deteriorating the image quality of the entire update image HZ included in the candidate entire-region storage data 200. Accordingly, without deteriorating the image quality of the image G currently displayed on the first image-receiving terminal 4, the entire image G can be updated. Moreover, since the untransmitted update data 200 in the first threshold-exceeding buffer are not transmitted to the first image-receiving terminal 4, a display time lag generated between the image-providing terminal 3 and the first image-receiving terminal 4 can be minimized. Further, the update data is kept from being stored in the first and second transmission buffers 711 and 721 to the maximum storage level. A shared display of the image G is kept from being interrupted. Particularly in the images such as drawings and documents to be displayed on a personal computer, an image quality is important and a movement is less important. Accordingly, the image-sharing system 7 according to the exemplary embodiment is effective. Consequently, the image-sharing system 7 can be provided that enables the image G currently displayed on the image-providing terminal 3 to be suitably displayed even on the first image-receiving terminal 4 having a different communication band.

(8) When update data 200, other than candidate entire-region storage data 200, transmitted during the time from the request of the candidate entire-region storage data 200 to the transmission thereof are stored in the second transmission buffer 721 and exceed the second threshold value, the server controller 83 specifies the second transmission buffer 721 as the second threshold-exceeding buffer. Then, the server controller 83 deletes the untransmitted update data 200 from the second threshold-exceeding buffer and stores the candidate entire-region storage data 200.

Accordingly, the update data 200 are kept from being stored to the maximum storage level in, for instance, the second transmission buffer 721 that is not specified as the first threshold-exceeding buffer.

### Modification(s) of Exemplary Embodiment(s)

Though the invention has been described above with reference to the exemplary embodiments, the scope of the invention is not limited thereto but includes various improvements and variations in the design as long as an object of the invention can be achieved.

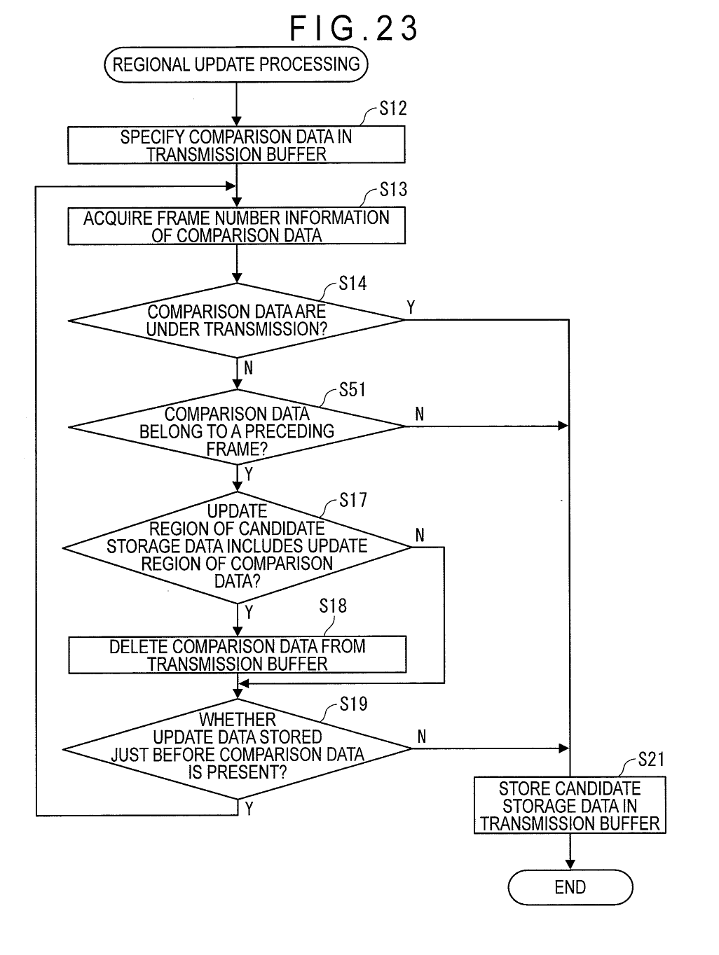

Specifically, as the regional update processing according to the first exemplary embodiment, a processing as shown in FIG. 23 may be performed.

In the regional update processing as shown in FIG. 23, the processings of Steps S12 to S14 according to the first exemplary embodiment are performed. When determining that the comparison data 200 are not being transmitted in Step S14, the comparison-target recognizing section 732 judges whether the frame of the comparison data 200 is identical with that of the preceding candidate storage data 200 or not (Step S51). When determining that the frame is identical with the frame of the preceding candidate storage data 200 in Step S51, the candidate storage data 200 are stored by the processing of Step S21. On the contrary, when determining that the frame is identical with the frame of the preceding candidate storage data 200 in Step S51, the processings of Steps S17 to S19 and S21 are performed as needed.

With this arrangement, although only the comparison data 200 having the frame identical with that of the preceding candidate storage data 200 can be deleted, the same advantages as the advantages (1) of the first exemplary embodiment can be obtained.

In the first exemplary embodiment, the processings of Steps S2 to S4 may not be performed. It should be noted that, with such an arrangement in which the processings of Steps S2 to S4 are not performed, the frame section flag 202 may not be provided in the update data 200.

Furthermore, in the first exemplary embodiment, after one of the comparison data 200 is deleted, the candidate storage data 200 may be stored without specifying next comparison data 200.

In the first and second exemplary embodiments, the setting processing of the optimum transmission band may not be performed.

Although a function for setting the candidate transmission band is provided to the image-sharing servers 6 and 8 and a function for setting the optimum transmission band is provided to the terminals 3 to 5, a function for setting both the candidate transmission band and the optimum transmission band may be provided to the image-sharing servers 6 and 8 or to the terminals 3 to 5. Further, a device for setting at least one of the candidate transmission band and the optimum transmission band may be provided in addition to the terminals 3 to 5 and the image-sharing servers 6 and 8.

In the second exemplary embodiment, a function for specifying the second threshold-exceeding buffer may not be provided. With such an arrangement having no function for specifying the second threshold-exceeding buffer, the second image-receiving terminal 5 may not be provided to the image-sharing system 7.

In the first exemplary embodiment, without deleting all the untransmitted update image G when receiving the entire image G as the update image H from the image-providing terminal 3, only the last update image H or update data H from the last to a predetermined sequence in the order for the update data to be stored may be deleted.

In the second exemplary embodiment, the entire image G may be constantly transmitted as the update data H from the image-providing terminal 3.

In the second exemplary embodiment, without deleting all the update image H untransmitted from the first and second threshold-exceeding buffers, only the last update image H or update data H from the last to a predetermined sequence in the order for the update data to be stored may be deleted.

The above-described components are configured as programs. However, the components may be configured in other configurations, for instance, as a hardware such as a circuit board or one IC (Integrated Circuit). When the components are read from the program or the recording medium, operation can be facilitated and usage can be easily expanded as described above.

Incidentally, a concrete structure and procedure of embodiment of the present invention can be also changed as long as the present invention can be achieved.

### Advantages of Exemplary Embodiments

As described above, in the above exemplary embodiments, when determining that the update region of the comparison data 200 in the second transmission buffer 721 is included in the update region R of the candidate storage data 200 when the predetermined reception band of the second image-receiving terminal 5 is smaller than the optimum transmission band of the image-providing terminal 3, the image-sharing server 6 deletes the comparison data 200 and stores the candidate storage data 200 in the second transmission buffer 721. Subsequently, the image-sharing server 6 transmits the update data 200 to the second image-receiving terminal 5 to update the image G currently displayed on the second image-receiving terminal 5 to the update image H.

Thus, the comparison data 200 having an update region duplicating that of the update image H of the candidate storage data 200 are deleted and not transmitted, and the to-be-transmitted update image H is transmitted to the second image-receiving terminal 5 without deterioration of an image quality. Accordingly, the currently displayed image G on the second image-receiving terminal 5 can be updated without deterioration of an image quality. Moreover, since the update image of a part of the comparison data 200 is not transmitted to the second image-receiving terminal 5, a display time lag generated between the image-providing terminal 3 and the second image-receiving terminal 5 can be minimized. Consequently, the image-sharing system 1 can be provided that enables the image G currently displayed on the image-providing terminal 3 to be suitably displayed even on the second image-receiving terminal 5 having a different communication band.

In another exemplary embodiment, when the storage amounts of the first transmission buffer 711 exceed the first threshold value, the image-sharing server 8 specifies the first transmission buffer 711 as the first threshold-exceeding buffer and requests the image-providing terminal 3 to transmit the candidate entire-region storage data 200 including the entire update image HZ. After receiving the candidate entire-region storage data 200, the image-sharing server 8 of the image-sharing system 7 deletes the update data 200 untransmitted from the first threshold-exceeding buffer and stores the candidate entire-region storage data 200. Subsequently, the image-sharing server 8 of the image-sharing system 7 transmits the candidate entire-region storage data 200 of the first threshold-exceeding buffer to the first image-receiving terminal 4 to update the image G currently displayed on the first image-receiving terminal 4 to the entire update image HZ.

Thus, the candidate entire-region storage data 200 is transmitted to the first image-receiving terminal 4 without deteriorating the image quality of the entire update image HZ included in the candidate entire-region storage data 200. Accordingly, without deteriorating the image quality of the image G currently displayed on the first image-receiving terminal 4, the entire image G can be updated. Moreover, since the update data 200 untransmitted from the first threshold-exceeding buffer are not transmitted to the first image-receiving terminal 4, a display time lag generated between the image-providing terminal 3 and the first image-receiving terminal 4 can be minimized. Further, the update data is kept from being stored in the first and second transmission buffers 711 and 721 to the maximum storage level. A shared display of the image G is kept from being interrupted. Consequently, the image-sharing system 7 can be provided that enables the image G currently displayed on the image-providing terminal 3 to be suitably displayed even on the first image-receiving terminal 4 having a different communication band.

### INDUSTRIAL APPLICABILITY

The invention is applicable to an image-sharing controller, an image-sharing system, an image-sharing controlling method, its program, and a recording medium recorded with the program.

1. An image-sharing controller that is connected to a plurality of terminals via a network and operates the plurality of terminals to display an image transmitted and received between the plurality of terminals, the image-sharing controller comprising:
a receiver that receives update data from a transmitting terminal of the plurality of terminals, the update data including: an update image of at least a part of an image currently displayed on the transmitting terminal; and update region location information showing a location of an update region of the update image in the image;
a transmission buffer that temporarily stores the update data received by the receiver;
a transmitter that transmits the update data stored in the transmission buffer to a receiving terminal of the plurality of terminals in an order for the update data to be stored to update the update region of the image currently displayed on the receiving terminal to the update image;
a comparison-target recognizing section that recognizes as comparison data the update data that is stored last in the order for the update data to be stored in the transmission buffer for storing the update data to be transmitted to the receiving terminal;
a deletion controller that deletes the comparison data when it is determined that an update region of the comparison data recognized by the comparison-target recognizing section is included in an update region of newly-received update data by the receiver; and
a storage controller that stores the newly-received update data in the transmission buffer.

2. The image-sharing controller according to claim 1, wherein
the comparison-target recognizing section recognizes as new comparison data the update data that is stored last in the order for the update data to be stored, after the comparison data are deleted by the deletion controller.

3. The image-sharing controller according to claim 1, wherein
the update data include display order information showing a display order of the image,
the comparison-target recognizing section recognizes the last update data and the update data having the same display order as the last update data as the comparison data having the same display order, and
the deletion controller deletes at least one of the comparison data having the same display order when it is determined that the update region of the at least one of the comparison data is included in the update region of the newly-received update data.

4. The image-sharing controller according to claim 3, wherein
when all the comparison data having the same display order are deleted by the deletion controller, the comparison-target recognizing section recognizes the update data just before the comparison data having the same display order as new comparison data having the same display order, and
the storage controller stores the update data in the transmission buffer when the at least one of the comparison data having the same display order is not deleted by the deletion controller.

5. The image-sharing controller according to claim 1, wherein
the deletion controller deletes the comparison data and untransmitted update data when it is determined that the update region of the newly-received update data covers an entire region of the image.

6. An image-sharing controller that is connected to a plurality of terminals via a network and operates the plurality of terminals to display an image transmitted and received between the plurality of terminals, the image-sharing controller comprising:
a receiver that receives update data from a transmitting terminal of the plurality of terminals, the update data including: an update image of at least a part of an image currently displayed on the transmitting terminal; and update region location information showing a location of an update region of the update image in the image;
a transmission buffer that temporarily stores the update data received by the receiver;
a transmitter that transmits the update data stored in the transmission buffer to a receiving terminal of the plurality of terminals in the order for the update data to be stored to update the update region of the image currently displayed on the receiving terminal to the update image, the number of the receiving terminal being equal to that of the transmission buffer;
a threshold excess judgment section that requests the transmitting terminal to transmit the update data of the entire region including the update image of the entire image when specifying the transmission buffer, in which the update data are stored over a threshold, as a threshold-exceeding buffer;
a deletion controller that deletes untransmitted update data stored in the threshold-exceeding buffer when the update data of the entire region are transmitted from the transmitting terminal as requested by the threshold excess judgment section; and
a storage controller that stores the update data of the entire region in the threshold-exceeding buffer.

7. The image-sharing controller according to claim 6, wherein
the threshold is defined by a first threshold value and a second threshold value for showing storage amounts of the update data, the second threshold value being smaller than the first threshold value,
the number of the transmission buffer is more than one,
the threshold excess judgment section requests the transmitting terminal to transmit the update data of the entire region when specifying a first threshold-exceeding buffer in which the storage amounts exceed the first threshold value,
the deletion controller deletes the update data stored in a second threshold-exceeding buffer when the threshold excess judgment section specifies the second threshold-exceeding buffer in which other update data transmitted until transmission of the update data of the entire region are stored and storage amounts of the other update data exceed the second threshold value, and
the storage controller stores the update data of the entire region in the second threshold-exceeding buffer.

8. An image-sharing system comprising:
a plurality of terminals capable of displaying an image; and
the image-sharing controller according to claim 1, the image-sharing controller being connected to the plurality of terminals via a network and operating the plurality of terminals to display an image transmitted and received between the plurality of terminals.

9. The image-sharing system according to claim 8, further comprising:
a candidate transmission-band setting section that recognizes a predetermined reception band for each of the plurality of terminals and sets a broader one of the predetermined reception bands of the other terminals as a candidate transmission band for the each of the plurality of the terminals; and
an optimum transmission band setting section that recognizes a predetermined transmission band for each of the plurality of terminals and sets a narrower one of the transmission band and the candidate transmission band as an optimum transmission band for the each of the plurality of terminals, wherein
the transmitting terminal transmits the update data in the optimum transmission band.

10. An image-sharing controlling method by a computer for displaying an image transmitted and received between a plurality of terminals connected to each other via a network, the image-sharing controlling method comprising:
receiving update data from a transmitting terminal of the plurality of terminals, the update data including: an update image of at least a part of an image currently displayed on the transmitting terminal; and update region location information showing a location of an update region of the update image in the image;
temporarily storing the update data in a transmission buffer;
transmitting the update data stored in the transmission buffer to a receiving terminal of the plurality of terminals in the order for the update data to be stored to update the update region of the image currently displayed on the receiving terminal to the update image;
recognizing last-stored update data in the order for the update data to be stored in the transmission buffer that stores the update data to be transmitted to the receiving terminal, as comparison data;
deleting the comparison data when determining that an update region of the comparison data recognized by the comparison-target recognizing section is included in an update region of newly-received update data by the receiver; and
storing the newly-received update data in the transmission buffer.

11. An image-sharing controlling method by a computer for displaying an image transmitted and received between a plurality of terminals connected to each other via a network, the image-sharing controlling method comprising:
receiving update data from a transmitting terminal of the plurality of terminals, the update data including: an update image of at least a part of an image currently displayed on the transmitting terminal; and update region location information showing a location of an update region of the update image in the image;
temporarily storing the update data in a transmission buffer;
transmitting the update data stored in the transmission buffer to a receiving terminal of the plurality of terminals in the order for the update data to be stored to update the update region of the image currently displayed on the receiving terminal to the update image, the number of the receiving terminal being equal to that of the transmission buffer;
requesting the transmitting terminal to transmit the update data of the entire region including the update image of the entire image when specifying the transmission buffer, in which the update data are stored over a threshold, as a threshold-exceeding buffer;
deleting untransmitted update data stored in the threshold-exceeding buffer when the update data of the entire region are transmitted from the transmitting terminal as requested by the threshold excess judgment section; and
storing the update data of the entire region in the threshold-exceeding buffer when the update data are deleted.

12. (canceled)

13. (canceled)

14. A recording medium on which the image-sharing controlling program for operating a computer to function as the image-sharing controller according to claim 1 is recorded in a computer-readable manner.

15. An image-sharing system comprising:
a plurality of terminals capable of displaying an image; and
the image-sharing controller according to claim 6, the image-sharing controller being connected to the plurality of terminals via a network and operating the plurality of terminals to display an image transmitted and received between the plurality of terminals.

16. The image-sharing system according to claim 15, further comprising:
a candidate transmission-band setting section that recognizes a predetermined reception band for each of the plurality of terminals and sets a broader one of the predetermined reception bands of the other terminals as a candidate transmission band for the each of the plurality of the terminals; and
an optimum transmission band setting section that recognizes a predetermined transmission band for each of the plurality of terminals and sets a narrower one of the transmission band and the candidate transmission band as an optimum transmission band for the each of the plurality of terminals, wherein
the transmitting terminal transmits the update data in the optimum transmission band.

17. A recording medium on which the image-sharing controlling program for operating a computer to function as the image-sharing controller according to claim 6 is recorded in a computer-readable manner.

18. A recording medium on which the image-sharing controlling program for operating a computer to execute the image-sharing controlling method according to claim 10 is recorded in a computer-readable manner.

19. A recording medium on which the image-sharing controlling program for operating a computer to execute the image-sharing controlling method according to claim 11 is recorded in a computer-readable manner.
